(19) United States
(12) Patent Application Publication
(10) Pub. No.: US 2017/0305203 A1
(43) Pub. Date: Oct. 26, 2017

(54) TIRE WITH UNIQUE TREAD BLOCK AND UP SIDEWALL DESIGNS

(71) Applicant: API, Inc., Scottsdale, AZ (US)

(72) Inventors: JEFF KREITZMAN, Scottsdale, AZ (US); Sunrong Gong, Shanghai (CN); Haipeng Zhao, Weihai (CN)

(21) Appl. No.: 15/497,649

(22) Filed: Apr. 26, 2017

Related U.S. Application Data
(60) Provisional application No. 62/327,660, filed on Apr. 26, 2016.

(51) Int. Cl. B60C 13/02; B60C 15/00; B60C 11/01

(52) U.S. Cl. CPC B60C 13/02; B60C 11/01; B60C 15/0036

(57) ABSTRACT

A tire including a sidewall, wherein the sidewall may include an upper sidewall. The upper sidewall may include a plurality of extruded, angled blocks proximate an outer edge of the tire. The tire may include a plurality of shoulder blocks. The plurality of shoulder blocks may be at the outer edge of the tire on a shoulder.

### RELATED CASES

This application claims the benefit of U.S. Provisional Application No. 62/327,660 filed on 26 Apr. 2016, the contents of which are all incorporated by reference.

### BACKGROUND

Tires may be used on multiple vehicle types (e.g., trucks, cars, trailers, etc.) to help travel under multiple on road/off road conditions. For instance, using trucks as an example, specific designs of tires may be used to help the truck travel under normal conditions, mud conditions, snow conditions, rain conditions, as well as other conditions.

### BRIEF SUMMARY OF DISCLOSURE

In one example implementation, a tire may include but is not limited to a sidewall, wherein the sidewall may include an upper sidewall. The upper sidewall may include a plurality of extruded, angled blocks proximate an outer edge of the tire. The tire may include a plurality of shoulder blocks. The plurality of shoulder blocks may be at the outer edge of the tire on a shoulder.

One or more of the following example features may be included. The plurality of shoulder blocks may include a plurality of first block types. The plurality of first block types may include a tread surface recessed from an edge of the tire. The plurality of shoulder blocks may include a plurality of second block types. The plurality of second block types may include a tread surface that extends outward. The plurality of shoulder blocks may include an alternating pattern using the plurality of first block types and the plurality of second block types. The tire may further comprise a plurality of lateral grooves of a plurality of center ribs. A first portion of the plurality of lateral grooves may be staggered from a second portion of the plurality of lateral grooves. One or more of the plurality of lateral grooves of the plurality of center ribs may be connected to one or more lateral grooves on the shoulder. The one or more of the plurality of lateral grooves of the plurality of center ribs may be narrower than the one or more lateral grooves on the shoulder. The one or more of the plurality of lateral grooves of the plurality of center ribs may have an angle of 62 degrees, and the one or more lateral grooves on the shoulder may have an angle of 72 degrees. The sidewall may include a 3-ply with 2 ply high turn-up construction. Only two rows of the plurality of shoulder blocks may contact a bottom surface at maximum tire load of the tire.

In another example implementation, a tire may include but is not limited to a sidewall, wherein the sidewall may include an upper sidewall. The upper sidewall may include a plurality of extruded, angled blocks proximate an outer edge of the tire. The tire may include a plurality of shoulder blocks. The plurality of shoulder blocks may be at the outer edge of the tire on a shoulder. The plurality of shoulder blocks may include a plurality of first block types. The plurality of shoulder blocks may include a plurality of second block types. The plurality of shoulder blocks may include an alternating pattern using the plurality of first block types and the plurality of second block types.

One or more of the following example features may be included. The plurality of first block types may include a tread surface recessed from an edge of the tire. The plurality of second block types may include a tread surface that extends outward. The tire may further comprise a plurality of lateral grooves of a plurality of center ribs. A first portion of the plurality of lateral grooves may be staggered from a second portion of the plurality of lateral grooves. One or more of the plurality of lateral grooves of the plurality of center ribs may be connected to one or more lateral grooves on the shoulder. The one or more of the plurality of lateral grooves of the plurality of center ribs may be narrower than the one or more lateral grooves on the shoulder. The one or more of the plurality of lateral grooves of the plurality of center ribs may have an angle of 62 degrees, and the one or more lateral grooves on the shoulder may have an angle of 72 degrees. The sidewall may include a 3-ply with 2 ply high turn-up construction. Only two rows of the plurality of shoulder blocks may contact a bottom surface at maximum tire load of the tire.

The details of one or more example implementations are set forth in the accompanying drawings and the description below. Other possible example features and/or possible example advantages will become apparent from the description, the drawings, and the claims. Some implementations may not have those possible example features and/or possible example advantages, and such possible example features and/or possible example advantages may not necessarily be required of some implementations.

### BRIEF DESCRIPTION OF THE DRAWINGS

FIG. 1 is an example diagrammatic view of a tire according to one or more example implementations of the disclosure;

FIG. 2 is an example diagrammatic view of a tire according to one or more example implementations of the disclosure;

FIG. 3 is an example diagrammatic view of a tire according to one or more example implementations of the disclosure;

FIG. 4 is an example diagrammatic view of a tire footprint according to one or more example implementations of the disclosure;

FIG. 5 is an example diagrammatic view of a tire according to one or more example implementations of the disclosure;

FIG. 6 is an example formula table of a tire according to one or more example implementations of the disclosure; and

FIG. 7 is an example size and specification table of a tire according to one or more example implementations of the disclosure.

Like reference symbols in the various drawings indicate like elements.

### DETAILED DESCRIPTION

Overview:

Tires may be used on multiple vehicle types (e.g., trucks, cars, trailers, etc.) to help travel under multiple on road/off road conditions. For instance, using trucks as an example, specific designs of tires may be used to help the truck travel on paved or non-paved roads under normal conditions, mud conditions, snow conditions, rain conditions, as well as other conditions. As will be discussed in greater detail below, the tire design of the present disclosure may include large tread blocks, which may include stiff tread that may provide stability in all road (on or off) conditions. In some implementations, the large tread blocks may provide, e.g., better handling performance, better tractions, and better wear. In some implementations, the tire may include large lateral grooves, which may provide quick and effective water dissipation (thus better hydroplaning protection, effective bite into snow or mud to provide better traction and/or mud-cleaning. In some implementations, the tire may include varied shoulder block shapes that may provide effective bite into snow or other soft surfaces to provide better handling and traction. In some implementations, the tire may include rubber blocks on the upper sidewall for added traction on snow, mud, or other soft surfaces, and may provide additional resistance to rock or debris puncture to the upper sidewall. In some implementations, the tire may include varied, angled grooves to provide better traction on soft surfaces and more effective water drainage. In some implementations, the tire may include staggered lateral grooves that may reduce air-pump noise and provide a smoother ride. In some implementations, the tire may include a strong three polyester ply and two nylon overlay construction to provide better stability and handling, better puncture resistance, and higher load carrying capacity.

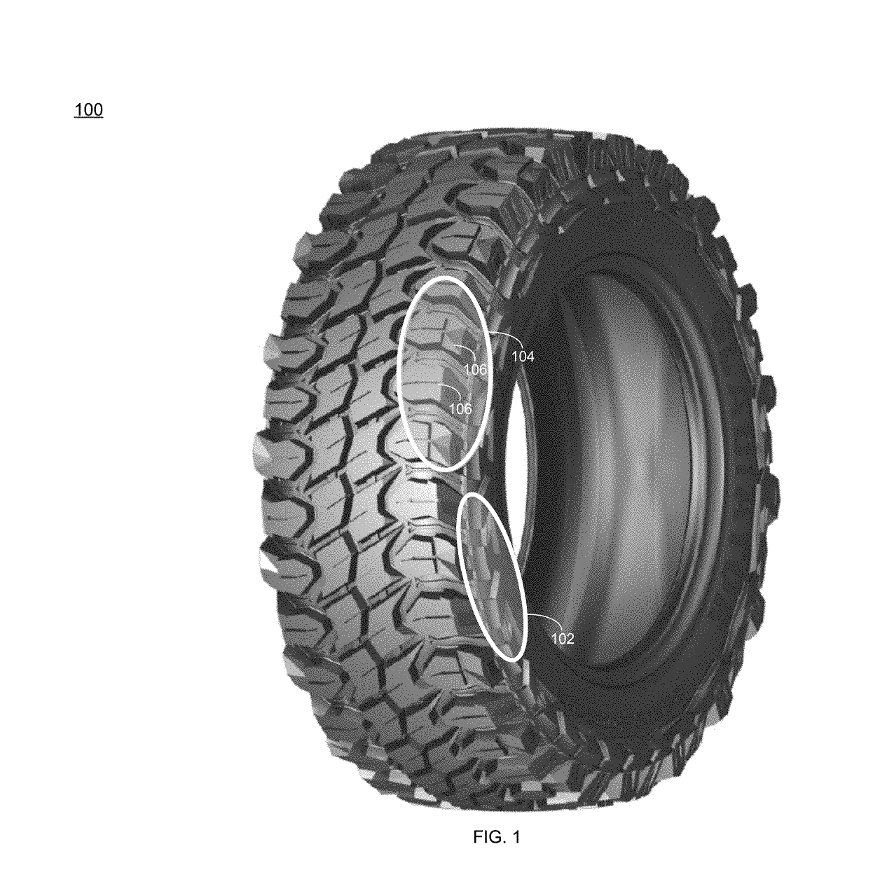

As discussed above and referring also at least to the example implementations of FIGS. 1-7, a tire may include but is not limited to a sidewall, wherein the sidewall may include an upper sidewall. The upper sidewall may include a plurality of extruded, angled blocks proximate an outer edge of the tire. The tire may include a plurality of shoulder blocks. The plurality of shoulder blocks may be at the outer edge of the tire on a shoulder.

In some implementations, a tire may include but is not limited to a sidewall, wherein the sidewall may include an upper sidewall. For example, and referring at least to the example implementation of FIG. 1, a tire (e.g., tire 100) is shown. In some implementations, tire 100 may include a sidewall, which may include an upper sidewall (e.g., upper sidewall 102). The sidewall may generally be described as the side of a tire between the tread shoulder and the rim bead.

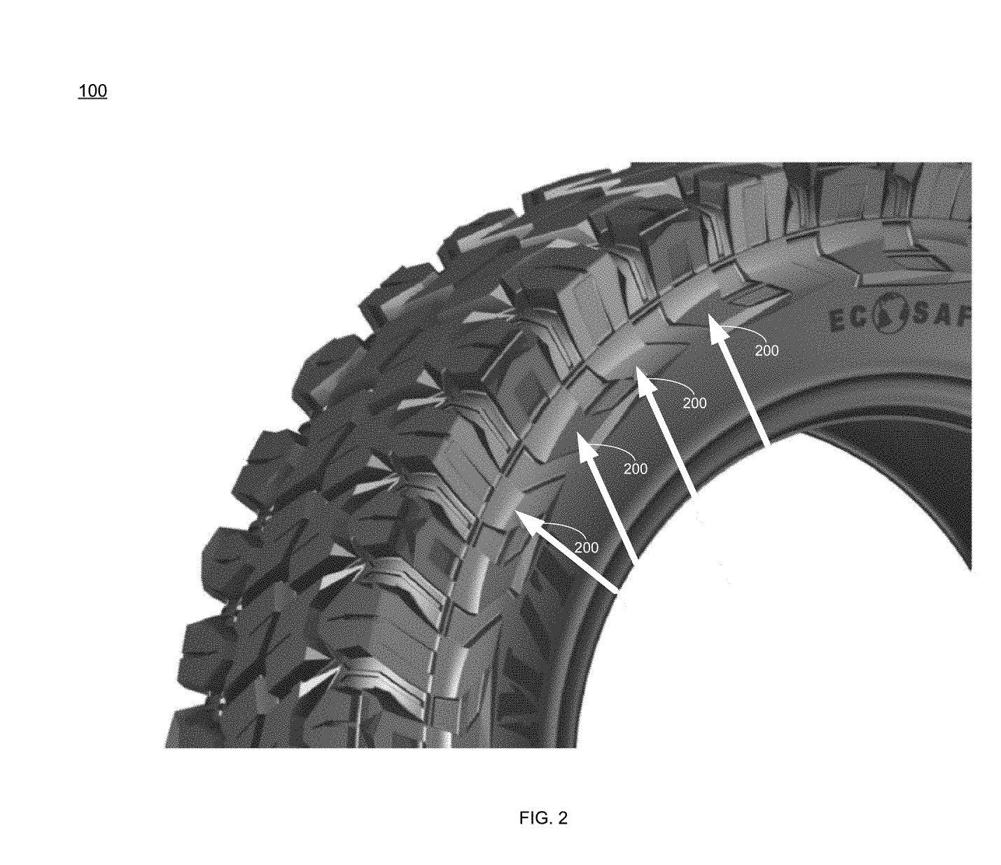

In some implementations, the upper sidewall may include a plurality of extruded, angled blocks proximate an outer edge of the tire. For example, and referring at least to the example implementation of FIG. 2, upper sidewall 102 of tire 100 may include a plurality of extruded, angled (winged) blocks (e.g., blocks 200) proximate the outer edge of tire 100. Notably, the extruded, angled blocks are not to be confused with general “patterned” up (upper) sidewall design, which may not be extruded and/or angled blocks. In some implementations, the extruded, angled blocks may enhance the traction performance on deep snow, mud, or other soft surfaces, by e.g., promoting better traction for improved braking and handling.

In some implementations, tire 100 may include a plurality of shoulder blocks. For example, and referring again at least to the example implementation of FIG. 1, tire 100 may include a shoulder (e.g., shoulder 104). In some implementations, the plurality of shoulder blocks (e.g., shoulder blocks 106) may be at the outer edge of tire 100 on shoulder 104.

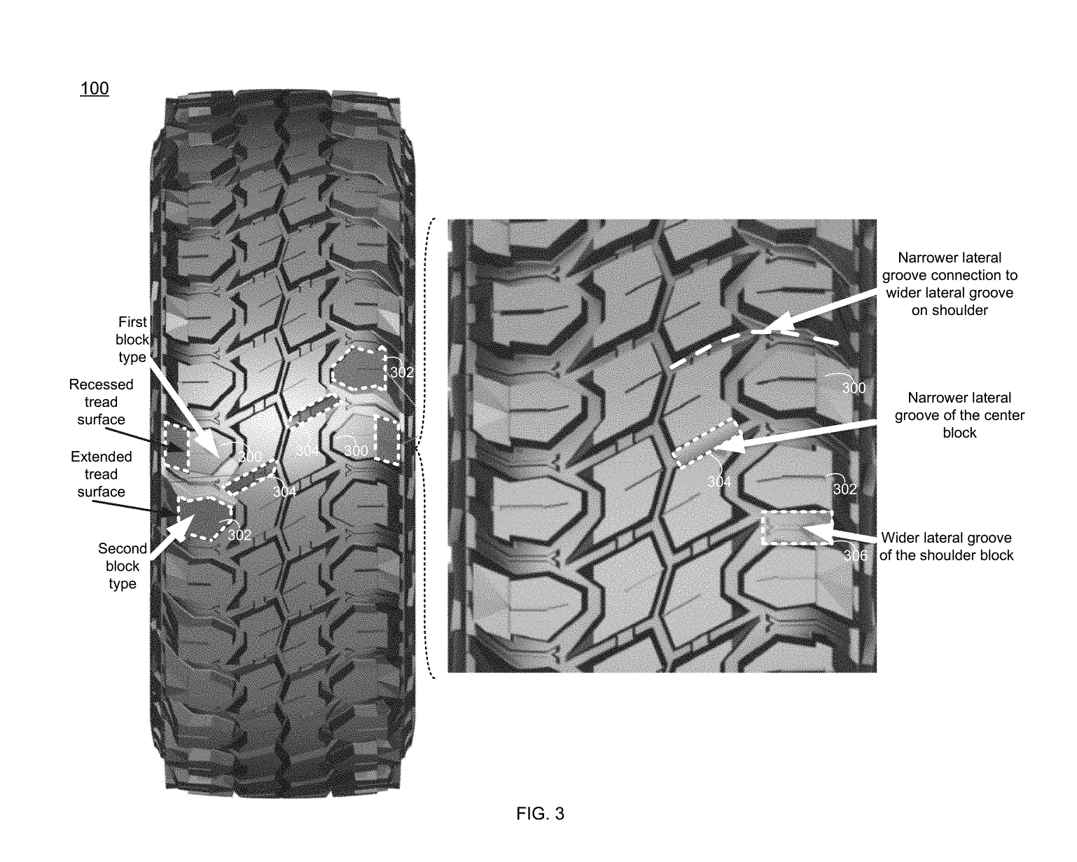

In some implementations, the plurality of shoulder blocks may include a plurality of first block types. For example, and referring again at least to the example implementation of FIG. 3, tire 100 may include a plurality of shoulder blocks, where a first block type of the plurality of shoulder blocks may be included. In the example, the plurality of first block types (e.g., first block type 300) may include a tread surface recessed from an edge of the tire. As shown in FIG. 3, first block type 300, the tread surface of the first block type 300 is recessed from the tread surface edge and from the edge of the second block type (discussed below) of tire 100, as shown via the dashed lines of the recessed portion of first block type 300. In some implementations, first block type 300 may be recessed from the edge by, e.g., 5 mm, and recessed from the tread surface by, e.g., 8 mm. It will be appreciated that other recess amounts may be used without departing from the scope of the disclosure. In some implementations, the top surface of the recessed part of first block type 300 may have a particular shape (e.g., a triangular shape) if viewed from the side of tire 100.

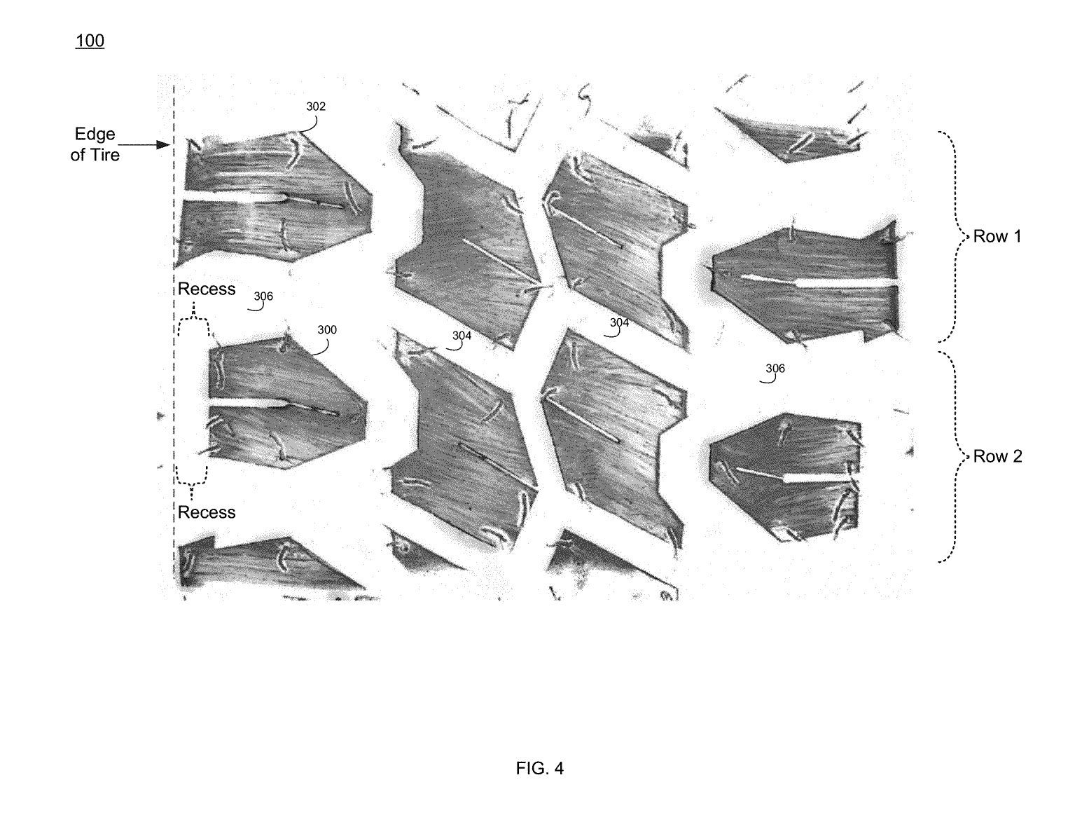

In some implementations, the plurality of shoulder blocks may include a plurality of second block types. For example, and referring still to the example implementation of FIG. 3, tire 100 may include a plurality of shoulder blocks, where a second block type of the plurality of shoulder blocks may be included. In the example, the plurality of second block types (e.g., second block type 302) may include a tread surface that extends outward. As shown via the dashed lines, the tread surface of the second block type 302 extends outward to the edge of tire 100. Referring at least to the example implementation of FIG. 4, a footprint of tire 100 is shown to help show the differences between the tread surface of the first block type 300 recessed from the edge of tire 100, and the tread surface of the second block type 302 extends outward to the edge of tire 100. As noted above, first block type 300 may be recessed from the edge by, e.g., 5 mm, and recessed from the tread surface by, e.g., 8 mm.

In some implementations, the plurality of shoulder blocks may include an alternating pattern using the plurality of first block types (e.g., first block type 300) and the plurality of second block types (e.g., second block type 302). In some implementations, the alternating pattern may include, e.g., first block type 300, second block type 302, first block type 300, second block type 302, etc. It will be appreciated that other alternating patterns may also be used without departing from the scope of the disclosure. For example, the alternating pattern may include first block type 300, first block type 300, second block type 302, second block type 302, first block type 300, first block type 300, etc. As such, the example alternating pattern shown via FIG. 3 should be taken as example only and not to otherwise limiting the scope of the disclosure. In some implementations, the repeating pattern may provide tire 100 more “bite” or grip into the mud or other soft surface, thus creating more lateral and longitudinal force to improve handling.

In some implementations, the tire may further comprise a plurality of lateral grooves of a plurality of center ribs. For example, and referring still to the example implementation of FIG. 3, tire 100 may include a plurality of lateral grooves (e.g., lateral groove 304 shown via dashed lines) of the plurality of center ribs. In some implementations, the width of the lateral grooves may range from, e.g., 25 to 30 mm, however, it will be appreciated that other size ranges may be used without departing from the scope of the disclosure. In some implementations, a first portion of the plurality of lateral grooves may be staggered from a second portion of the plurality of lateral grooves. For example, as shown via FIG. 3, each of the lateral grooves 304 is shown staggered (i.e., offset) from one another. Staggering the lateral grooves may provide resistance to air flow in the footprint, which may help with noise suppression. For example, one of the tire noise mechanism is a so-called air pumping effect. When the tire rotates and its surfaces comes into contact with the road surface, most of the air between the tire and the road surface may get pushed out, but the air in the tread grooves may become trapped and then compressed, creating the kind of ‘whistling” noise. When the grooves are inline, it may be easier for the compressed air to travel, thus causing more noise. Staggered grooves may provide no direct path for noise travel, thus reducing noise.

In some implementations, one or more of the plurality of lateral grooves of the plurality of center ribs may be connected to one or more lateral grooves on the shoulder. For example, and referring still to the example implementation of FIG. 3, lateral groove 304 (of the center ribs) may be connected to another lateral groove (e.g., lateral groove 306 shown via white dashed lines) on the shoulder of tire 100.

In some implementations, the one or more of the plurality of lateral grooves of the plurality of center ribs may be narrower than the one or more lateral grooves on the shoulder. For example, and referring still to the example implementation of FIG. 3, lateral groove 304 (of the center ribs) may be narrower than lateral groove 306 (on the shoulder) of tire 100. The narrower lateral grooves 304 being connected with wider lateral grooves 306 may additionally/alternatively reduce the above-noted air pumping effect, as the wider shoulder grooves may provide “pressure” release for the trapped air. In some implementations, the ratio of narrower lateral groove 304 to wider lateral groove 306 may be, e.g., 1:2, however, it will be appreciated that other ratios may be used on lateral groove 304 and lateral groove 306 without departing from the scope of the disclosure.

In some implementations, the one or more of the plurality of lateral grooves of the plurality of center ribs (e.g., lateral groove 304) may have an angle of 62 degrees, and the one or more lateral grooves on the shoulder (e.g., lateral groove 306) may have an angle of 72 degrees. It will be appreciated that other angles may be used on lateral groove 304 and lateral groove 306 without departing from the scope of the disclosure. As such, the example angles of 62 and 72 degrees should be taken as example only and not to otherwise limit the scope of the disclosure.

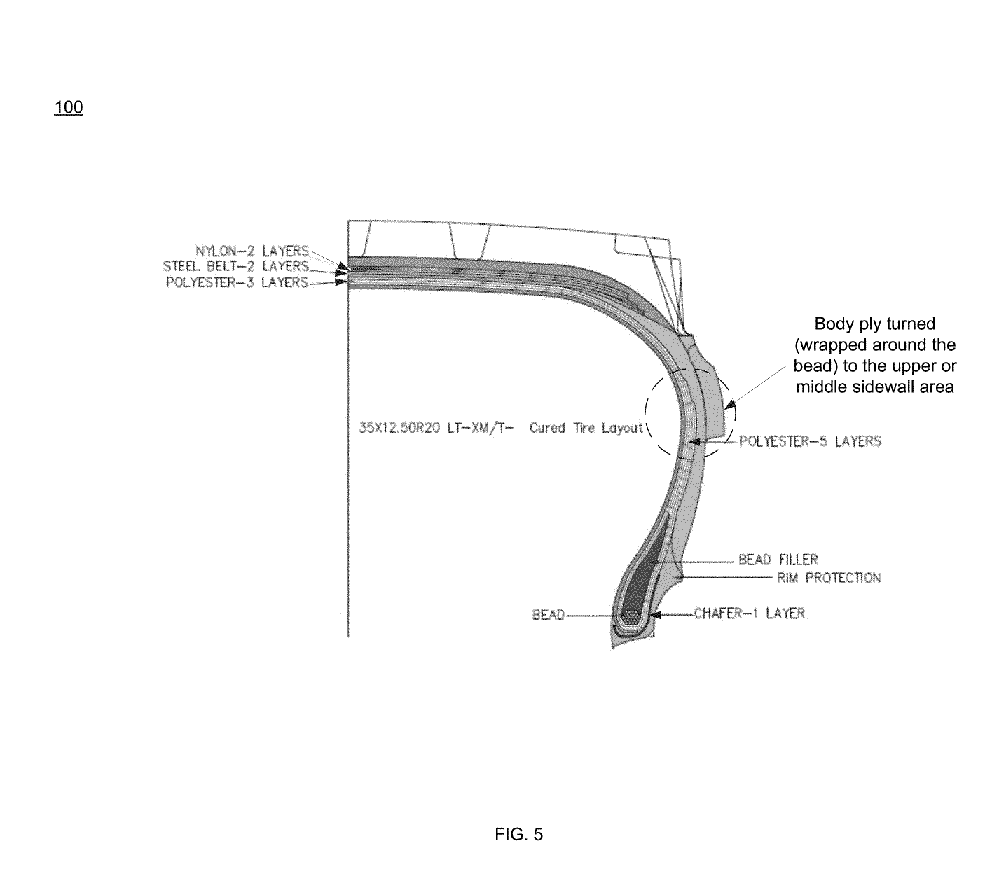

In some implementations, the sidewall may include a 3-ply with 2 ply high turn-up construction. For example, and referring to the example implementation of FIG. 5, tire 100 may include a lower sidewall, which may include a 3-ply with 2 ply high turn-up construction. This means that the tire carcass may have a total of 3 plies, with 2 of the 3 plies being high turn-up. For example, when a body ply is turned (wrapped around the bead) to the upper or middle sidewall area, it may be referred to as high turn-up construction. The 3-ply sidewall with the high turn-up construction may act as an extra layer on reinforcement to increase puncture resistance of the low sidewall area. In some implementations, three layers of polyester cord fabric and two high strength layers of steel belts, and two layers of nylon in the tread may guard against rock and debris puncture to the tread area. In some implementations, tire 100 may include a plurality of beads in a bead filler, surrounded by five layers of polyester, and one chafer layer.

In some implementations, only two rows of the plurality of shoulder blocks may contact a bottom surface at maximum tire load of the tire. For example, and referring again to the example implementation of FIG. 4, assume that the maximum tire load of tire 100 is being applied (e.g., the maximum tire load specified in the T&RA manual and stamped on the tire sidewall, such as the example 35X12.5R20 tire with the max load of 1450 kg). In the example, only two rows (or substantially only two rows) of the plurality of shoulder blocks is making contact with the bottom surface. Thus, in the example, at the maximum tire load, at least two rows, but less than 3 full rows of the plurality of shoulder blocks is making contact with the bottom surface. Large tread blocks may provide stiff tread for enhanced off-road and all season performance. Large tread block may be quantified by a block's area and its relative size to tire-road contact area. Block surface area may vary with tire size, but using 35″ outer diameter size as an sample, the surface area of a block may range from, e.g., 9500-14000 mm². For all sizes, at maximum tire load there are two rows of tread blocks that are in contact with the road, in comparison other tires of similar application having 3-4 rows of tread blocks in contact with the road.

In some implementations, tire 100 may have a ratio of rubber to void on the tread of, e.g., 5.4:4.6. This may allow for optimum balances for on-road and off-road (e.g., mud) performances. It will be appreciated that other ratios may be used without departing from the scope of the disclosure.

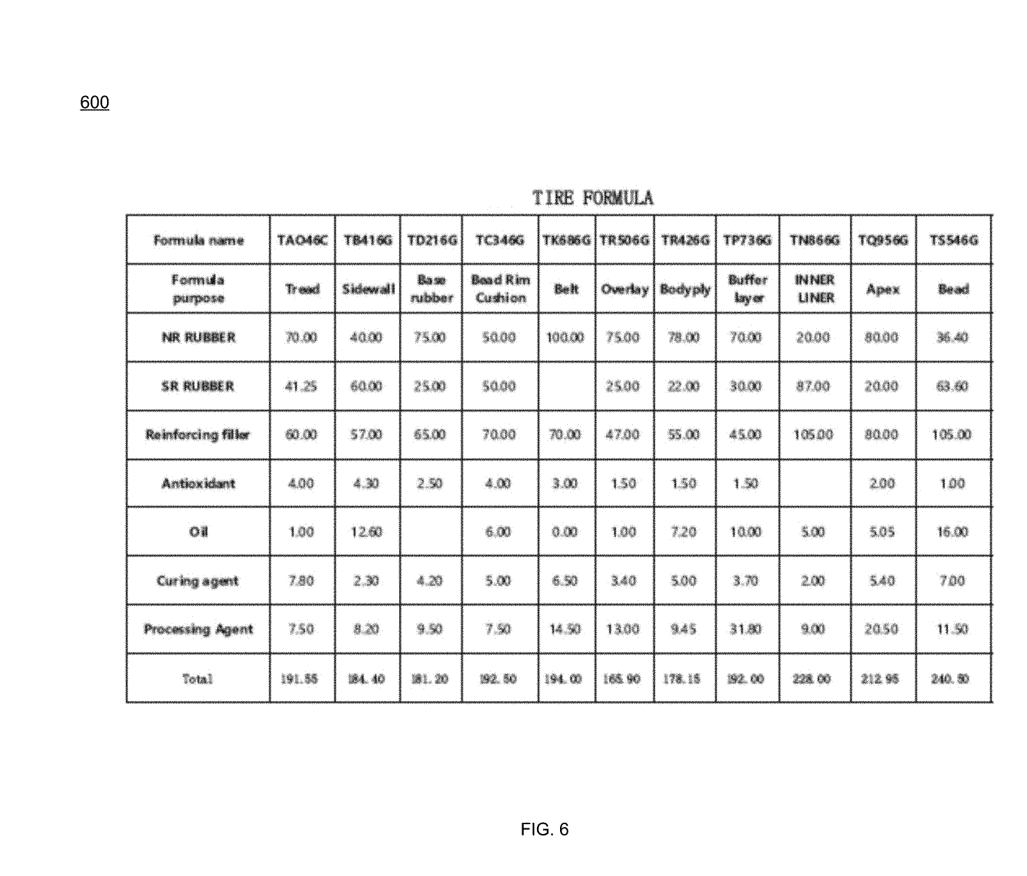

In some implementations, tire 100 may be formulated using a variety of different materials for one or more of its sections (e.g., tread, sidewall, base rubber, bead rim cushion, belt, overlay, bodyply, buffer layer, inner liner, apex, bead, etc.). Table 600 shown in FIG. 6 shows example materials and amounts of materials used for each of its section. It will be appreciated that various other materials and amounts may be used without departing from the scope of the disclosure. As such, the material in table 600 should be taken as example only and not to otherwise limit the scope of the disclosure.

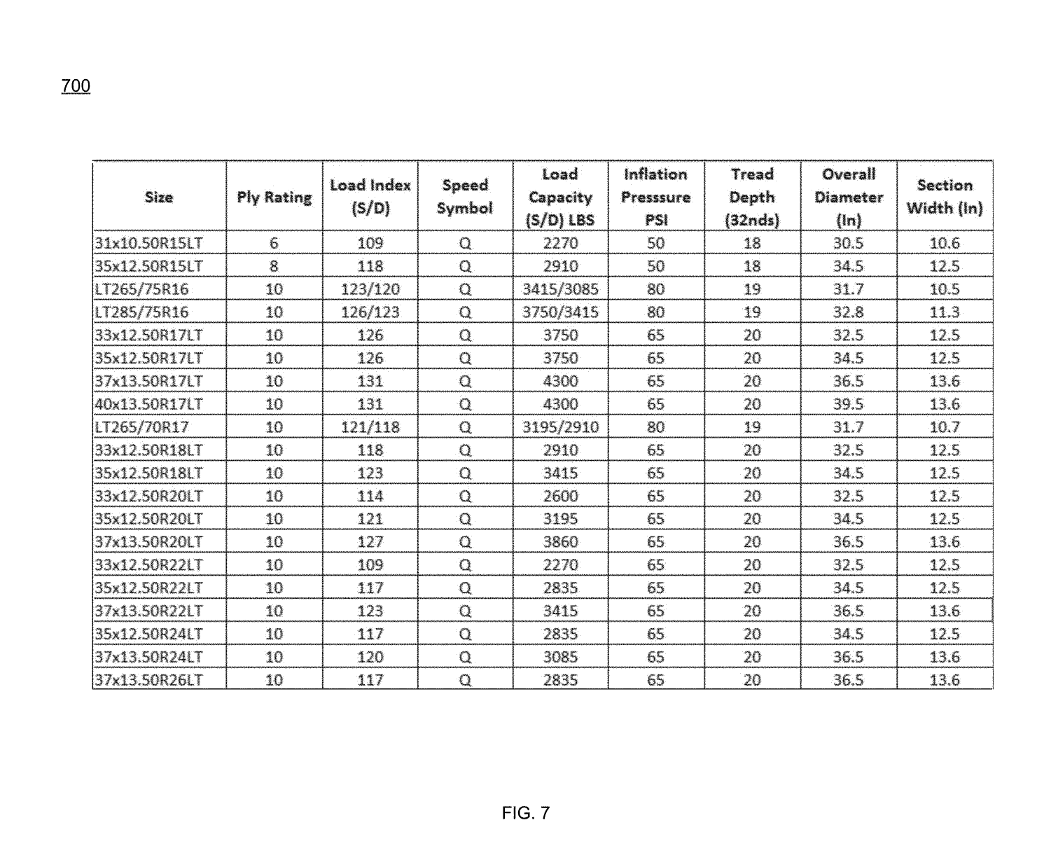

In some implementations, tire 100 may come in a variety of sizes with various specifications (e.g., tire size, load index, speed symbol, ply rating, outside diameter, section width, tread depth, load cap, etc.). Table 700 shown in FIG. 7 shows example specifications that may be used for different tire sizes. It will be appreciated that various other sizes with differing specifications may be used without departing from the scope of the disclosure. As such, the sizes and specifications in table 700 should be taken as example only and not to otherwise limit the scope of the disclosure.

General:

The terminology used herein is for the purpose of describing particular implementations only and is not intended to be limiting of the disclosure. As used herein, the singular forms “a”, “an” and “the” are intended to include the plural forms as well, unless the context clearly indicates otherwise. As used herein, the language “at least one of A, B, and C” (and the like) should be interpreted as covering only A, only B, only C, or any combination of the three, unless the context clearly indicates otherwise. It will be further understood that the terms “comprises” and/or “comprising,” when used in this specification, specify the presence of stated features, integers, elements, and/or components, but do not preclude the presence or addition of one or more other features, integers, elements, components, and/or groups thereof.

The corresponding structures, materials, acts, and equivalents (e.g., of all means or step plus function elements) that may be in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications, variations, substitutions, and any combinations thereof will be apparent to those of ordinary skill in the art without departing from the scope and spirit of the disclosure. The implementation(s) were chosen and described in order to explain the principles of the disclosure and the practical application, and to enable others of ordinary skill in the art to understand the disclosure for various implementation(s) with various modifications and/or any combinations of implementation(s) as are suited to the particular use contemplated.

Having thus described the disclosure of the present application in detail and by reference to implementation(s) thereof, it will be apparent that modifications, variations, and any combinations of implementation(s) (including any modifications, variations, substitutions, and combinations thereof) are possible without departing from the scope of the disclosure defined in the appended claims.

What is claimed is:

1. A tire comprising:
a sidewall including an upper sidewall, wherein the upper sidewall includes a plurality of extruded, angled blocks proximate an outer edge of the tire; and
a plurality of shoulder blocks, wherein the plurality of shoulder blocks are at the outer edge of the tire on a shoulder.

2. The tire of claim 1 wherein the plurality of shoulder blocks includes a plurality of first block types.

3. The tire of claim 2 wherein the plurality of first block types includes a tread surface recessed from an edge of the tire.

4. The tire of claim 2 wherein the plurality of shoulder blocks includes a plurality of second block types.

5. The tire of claim 4 wherein the plurality of second block types includes a tread surface that extends outward.

6. The tire of claim 4 wherein the plurality of shoulder blocks includes an alternating pattern using the plurality of first block types and the plurality of second block types.

7. The tire of claim 1 further comprising a plurality of lateral grooves of a plurality of center ribs.

8. The tire of claim 7 wherein a first portion of the plurality of lateral grooves are staggered from a second portion of the plurality of lateral grooves.

9. The tire of claim 8 wherein one or more of the plurality of lateral grooves of the plurality of center ribs are connected to one or more lateral grooves on the shoulder.

10. The tire of claim 9 wherein the one or more of the plurality of lateral grooves of the plurality of center ribs are narrower than the one or more lateral grooves on the shoulder.

11. The tire of claim 10 wherein the one or more of the plurality of lateral grooves of the plurality of center ribs have an angle of 62 degrees, and wherein the one or more lateral grooves on the shoulder have an angle of 72 degrees.

12. The tire of claim 1 wherein the sidewall includes a 3-ply with 2 ply high turn-up construction.

13. The tire of claim 1 wherein only two rows of the plurality of shoulder blocks contact a bottom surface at maximum tire load of the tire.

14. A tire comprising:
a sidewall including an upper sidewall, wherein the upper sidewall includes a plurality of extruded, angled blocks proximate an outer edge of the tire; and
a plurality of shoulder blocks, wherein the plurality of shoulder blocks are at the outer edge of the tire on a shoulder, wherein the plurality of shoulder blocks includes a plurality of first block types, wherein the plurality of shoulder blocks includes a plurality of second block types, and wherein the plurality of shoulder blocks includes an alternating pattern using the plurality of first block types and the plurality of second block types.

15. The tire of claim 14 wherein the plurality of first block types includes a tread surface recessed from an edge of the tire.

16. The tire of claim 14 wherein the plurality of second block types includes a tread surface that extends outward.

17. The tire of claim 14 further comprising a plurality of lateral grooves of a plurality of center ribs.

18. The tire of claim 17 wherein a first portion of the plurality of lateral grooves are staggered from a second portion of the plurality of lateral grooves.

19. The tire of claim 17 wherein one or more of the plurality of lateral grooves of the plurality of center ribs are connected to one or more lateral grooves on the shoulder.

20. The tire of claim 19 wherein the one or more of the plurality of lateral grooves of the plurality of center ribs are narrower than the one or more lateral grooves on the shoulder.
